(19) United States
(12) Patent Application Publication
(10) Pub. No.: US 2026/0188557 A1
(43) Pub. Date: Jul. 2, 2026

(54) COIL COMPONENT

(71) Applicant: TDK Corporation, Tokyo (JP)

(72) Inventors: Yuya OSHIMA, Tokyo (JP); Yuma ISHIKAWA, Tokyo (JP); Kouichi KAKUDA, Tokyo (JP); Takuya NIIBORI, Tokyo (JP); Shigeshi OSAWA, Akita (JP); Kazuma SUGAWARA, Tokyo (JP); Kaori SASAKI, Tokyo (JP); Shota KAIGUCHI, Tokyo (JP); Junya OKAZAKI, Tokyo (JP); Makoto YOSHINO, Tokyo (JP)

(73) Assignee: TDK Corporation, Tokyo (JP)

(21) Appl. No.: 19/426,827

(22) Filed: Dec. 19, 2025

(30) Foreign Application Priority Data
Dec. 26, 2024 (JP) 2024-230747

(51) Int. Cl. H01F 27/24; H01F 27/29

(52) U.S. Cl. CPC H01F 27/24; H01F 27/292

(57) ABSTRACT

A coil component includes an element body, and a coil disposed in the element body. The element body includes a first region and a second region in an element body portion in which the coil is disposed. The first region includes a magnetic material. The second region is located adjacent to and in contact with the first region and includes a material having a shrinkage rate larger than a shrinkage rate of the magnetic material.

### CROSS-REFERENCE TO RELATED APPLICATIONS

This application is based upon and claims the benefit of priority from Japanese Patent Application No. 2024-230747, filed on Dec. 26, 2024, the entire contents of which are incorporated herein by reference.

### BACKGROUND

### Field

Aspects of the present disclosure relate to a coil component.

### Description of the Related Art

Known coil components include an element body and a coil disposed in the element body (for example, refer to Japanese Unexamined Patent Publication No. H8-55726).

### SUMMARY

A coil component according to one aspect of the present disclosure includes an element body and a coil in the element body. The element body includes a first region and a second region in an element body portion in which the coil is disposed. The first region includes a magnetic material. The second region is located adjacent to and in contact with the first region and includes a material having a shrinkage rate larger than a shrinkage rate of the magnetic material.

A coil component according to another aspect of the present disclosure includes an element body and a coil in the element body. The element body includes a pair of end surfaces opposing each other and a side surface coupling the pair of end surfaces. The pair of end surfaces oppose each other in a coil axis direction of the coil. The element body includes a first region and a second region that are adjacent to each other in the coil axis direction of the coil and are in contact with each other. The first region includes a first surface region included in the side surface. The second region includes a second surface region that is included in the side surface and is recessed more than the first surface region.

### BRIEF DESCRIPTION OF THE DRAWINGS

FIG. 1 is a perspective view illustrating a coil component according to an example;

FIG. 2 is an exploded perspective view illustrating a coil and connection portions;

FIG. 3 is a diagram illustrating a cross-sectional configuration of the coil component according to the example;

FIG. 4 is a diagram illustrating a cross-sectional configuration of an element body;

FIG. 5 is a diagram illustrating a cross-sectional configuration of the element body;

FIG. 6 is a diagram schematically illustrating an action of compressive stress and tensile stress; and

FIG. 7 is a view illustrating a coil component according to a modification of the example.

### DETAILED DESCRIPTION

In the following description, with reference to the drawings, the same reference numbers are assigned to the same components or to similar components having the same function, and overlapping description is omitted.

Some aspects of the present disclosure provide a coil component that can improve a peak value of impedance.

The present inventors conducted research and investigation on a coil component that can improve the peak value of impedance. Consequently, the present inventors newly obtained the following findings.

The inductance characteristics of a magnetic material change depending on the stress acting on the magnetic material. The stress acting on the magnetic material includes, for example, compressive stress or tensile stress. As the compressive stress acting on the magnetic material increases, the inductance characteristics tend to decrease. As the tensile stress acting on the magnetic material increases, the inductance characteristics tend to decrease. However, a balanced state between the compressive stress and tensile stress acting on the magnetic material can improve the inductance characteristics. An improvement in the inductance characteristics can also lead to an improvement in the peak value of impedance.

The present inventors further conducted research and investigation on a coil component capable of balancing compressive stress and tensile stress acting on a magnetic material. Consequently, the present inventors have newly obtained the following findings.

The element body is obtained, for example, by firing a green element body. That is, the element body is obtained, for example, through a firing process. In the firing process, the green element body shrinks. In this case, stress may act on the obtained element body.

In a configuration in which the element body, in an element body portion where a coil is disposed, includes a first region including a magnetic material, and a second region that is located adjacent to and in contact with the first region and includes a material having a shrinkage rate larger than that of the magnetic material, the second region shrinks more than the first region. In this configuration, the first region and the second region are in contact with each other. Therefore, due to the shrinkage of the second region, a compressive stress acts on the first region from a region near a surface of the element body toward an inside of the element body. A force based on this compressive stress is confined inside the element body, and is converted into a force directed from the first region toward the second region. This force directed from the first region toward the second region acts on the first region as tensile stress. The above-described configuration tends to balance the compressive stress and tensile stress acting on the first region in the element body portion where the coil is disposed. Consequently, the above-described configuration can improve the peak value of impedance.

The present inventors have conceived the following aspects based on the new findings regarding the compressive stress and tensile stress.

One aspect of the present disclosure relates to a coil component that includes an element body and a coil disposed in the element body. The element body includes a first region and a second region in an element body portion in which the coil is disposed. The first region includes a magnetic material. The second region is located adjacent to and in contact with the first region and includes a material having a shrinkage rate larger than a shrinkage rate of the magnetic material.

Another aspect of the present disclosure relates to a coil component that includes an element body and a coil in the element body. The element body includes a pair of end surfaces opposing each other and a side surface coupling the pair of end surfaces. The pair of end surfaces oppose each other in a coil axis direction of the coil. The element body includes a first region and a second region that are adjacent to each other in the coil axis direction of the coil and are in contact with each other. The first region includes a first surface region included in the side surface. The second region includes a second surface region that is included in the side surface and is recessed more than the first surface region.

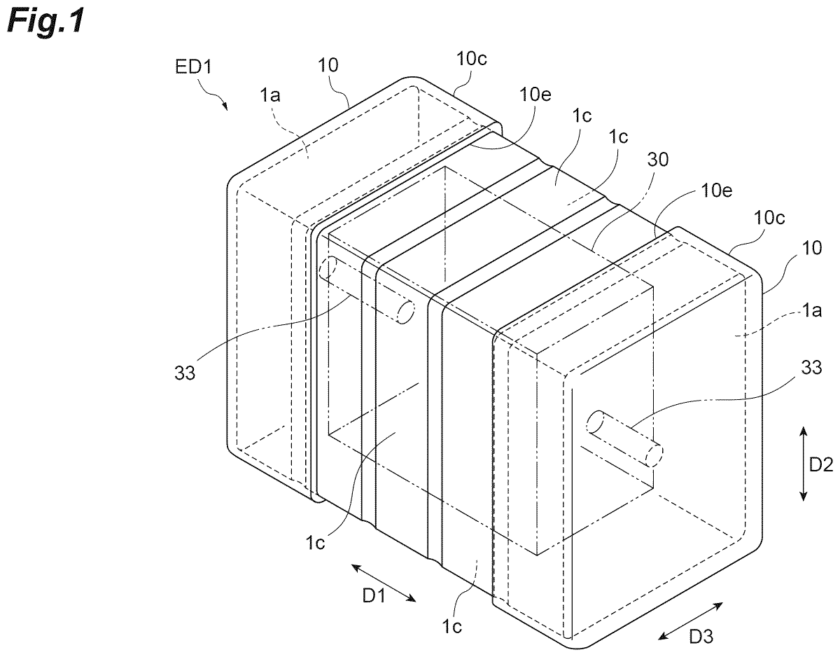

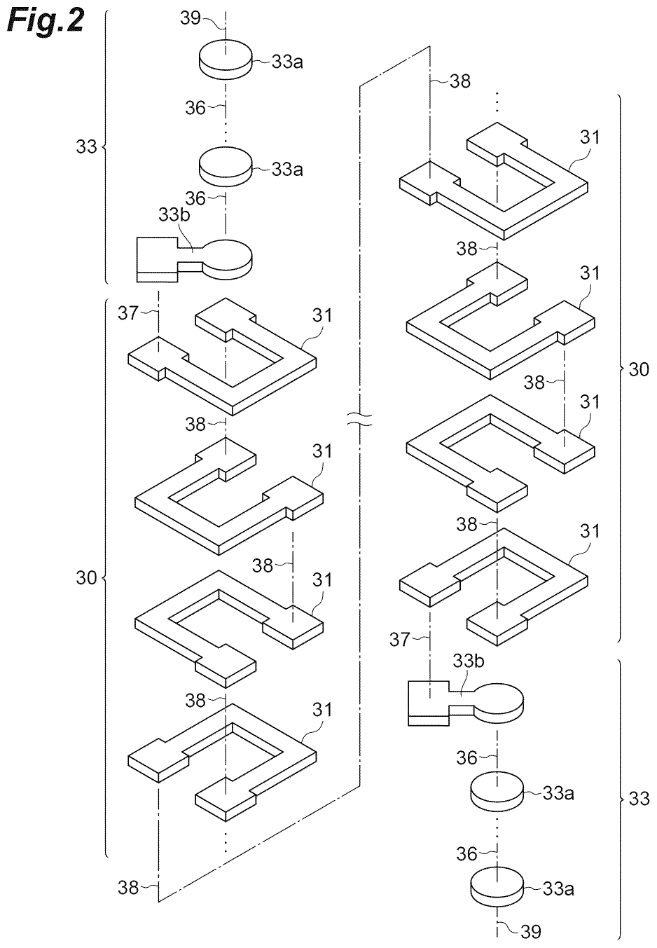

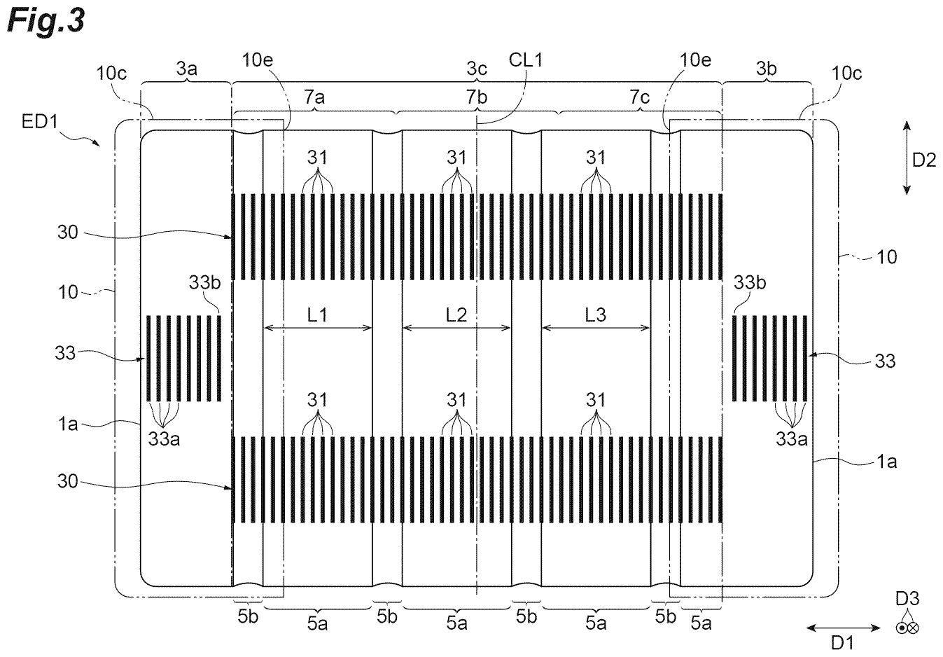

A configuration of a coil component ED1 according to an example will be described with reference to FIGS. 1 to 3. FIG. 1 is a perspective view illustrating a coil component according to the example. FIG. 2 is an exploded perspective view illustrating a coil and connection portions. FIG. 3 is a diagram illustrating a cross-sectional configuration of the coil component according to the example. In FIG. 3, hatching indicating a cross section is omitted.

As illustrated in FIGS. 1 to 3, the coil component ED1 includes an element body 1, a plurality of external electrodes 10, and a coil 30. The plurality of external electrodes 10 include a pair of external electrodes 10. The plurality of external electrodes 10 are disposed on the element body 1. The coil 30 is disposed in the element body 1 and is electrically connected to the plurality of external electrodes 10. The coil 30 is disposed such that a coil axis is along a first direction D1. The first direction D1 includes a coil axis direction of the coil 30.

The element body 1 has, for example, a rectangular parallelepiped shape. For example, the rectangular parallelepiped shape includes a rectangular parallelepiped shape in which corners and ridges are chamfered, or a rectangular parallelepiped shape in which corners and ridges are rounded. The element body 1 includes a pair of end surfaces 1a opposing each other and a side surface coupling the pair of end surfaces 1a. The side surface includes a plurality of side surfaces. For example, the element body 1 includes four side surfaces 1c. The surface of the element body 1 includes the pair of end surfaces 1a and the four side surfaces 1c. Each of the pair of end surfaces 1a and the four side surfaces 1c has a rectangular shape. For example, the rectangular shape includes a shape in which each corner is chamfered or a shape in which each corner is rounded.

The pair of end surfaces 1a oppose each other in the first direction D1. That is, the pair of end surfaces 1a oppose each other in the coil axis direction of the coil 30. One pair of side surfaces 1c of the four side surfaces 1c oppose each other in the second direction D2. Another pair of side surfaces 1c oppose each other in the third direction D3. The four side surfaces 1c extend in the first direction D1 to couple the pair of end surfaces 1a. The first direction D1 intersects with the second direction D2 and intersects with the third direction D3. The second direction D2 intersects with the third direction D3. The first direction D1, the second direction D2, and the third direction D3 are, for example, perpendicular to each other.

For example, a length of the element body 1 in the first direction D1 is from 0.4 mm to 1.6 mm. For example, a length of the element body 1 in the second direction D2 is from 0.2 mm to 1.0 mm. For example, a length of the element body 1 in the third direction D3 is from 0.2 mm to 0.8 mm. In the element body 1, for example, the first direction D1 includes a longitudinal direction.

The pair of external electrodes 10 are disposed at both ends of the element body 1. One external electrode 10 is disposed, for example, on one end surface 1a. Another external electrode 10 is disposed, for example, on another end surface 1a. The pair of external electrodes 10 are separated from each other in the first direction D1. Each of the pair of external electrodes 10 includes an electrode portion located on a corresponding end surface 1a of the pair of end surfaces 1a, and an electrode portion 10c located on the four side surfaces 1c.

Each of the electrode portions 10c is located on the four side surfaces 1c. Each electrode portion 10c includes an end edge 10e. One electrode portion 10c extends on the four side surfaces 1c, for example, from one end surface 1a to the end edge 10e in a direction toward another end surface 1a. Another electrode portion 10c extends on the four side surfaces 1c, for example, from the other end surface 1a to the end edge 10e in a direction toward the one end surface 1a. The end edge 10e is located on the four side surfaces 1c. The end edge 10e includes an end edge of the external electrode 10 located on the side surfaces 1c. That is, the external electrode 10 includes the end edge located on the side surfaces 1c.

The external electrode 10 includes an electrically conductive material. The electrically conductive material includes, for example, Ag, Pd, Cu, or Al. The electrically conductive material includes, for example, an Ag—Pd alloy, an Ag—Cu alloy, an Ag—Au alloy, or an Ag—Pt alloy. The external electrode 10 may include, for example, a plating film. The plating film includes, for example, a Ni plating film, a Sn plating film, a Cu plating film, or an Au plating film. The plating film may have a multilayer structure. For example, the plating film may include the Ni plating film and the Sn plating film formed on the Ni plating film. For example, a thickness of a portion located on the end surface 1a of the external electrode 10 is from 5 μm to 50 μm.

The coil 30 includes a plurality of coil conductors 31. The coil 30 may include at least one coil conductor 31. The coil conductors 31 are disposed to at least partially overlap each other as viewed from the first direction D1. Each coil conductor 31 has, for example, a shape in which a part of a loop is interrupted. Each coil conductor 31 includes a pair of ends. Each coil conductor 31 extends between the pair of ends along an annular path. Among the plurality of coil conductors 31, adjacent coil conductors 31 are connected to each other at the ends of the respective coil conductors 31 via a through-hole conductor 38. As viewed from the first direction D1, the above-described adjacent coil conductors 31 overlap at their corresponding ends. The coil component ED1 includes a pair of connection portions 33 disposed at both ends of the coil 30. The pair of connection portions 33 electrically connect the coil 30 and the pair of external electrodes 10. In FIG. 1, the two-dot chain line schematically indicates the contour of the outer shape of the coil 30 and the connection portions 33.

As illustrated in FIG. 2, each of the pair of connection portions 33 includes, for example, a plurality of conductors 33a and one conductor 33b. Among the plurality of conductors 33a, conductors 33a adjacent to each other are connected via a through-hole conductor 36. The through-hole conductor 36 electrically connects the conductors 33a adjacent to each other. The conductor 33a is, for example, not exposed on the end surface 1a. In a configuration in which the conductor 33a is not exposed on the end surface 1a, for example, the conductor 33a farthest from the coil 30 among the plurality of conductors 33a is connected to the external electrode 10 via a through-hole conductor 39. The through-hole conductor 39 is, for example, located between the conductor 33a farthest from the coil 30 and the external electrode 10, and electrically connects the conductor 33a farthest from the coil 30 and the external electrode 10. For example, the conductor 33a farthest from the coil 30 may be exposed on the end surface 1a. In a configuration in which the conductor 33a is exposed on the end surface 1a, the conductor 33a exposed on the end surface 1a is directly connected to the external electrode 10, and each of the pair of connection portions 33 does not include the through-hole conductor 39. The coil component ED1 may include a configuration in which one connection portion 33 of the pair of connection portions 33 includes the through-hole conductor 39, and another connection portion 33 of the pair of connection portions 33 does not include the through-hole conductor 39. In this configuration, the one connection portion 33 is connected to the external electrode 10 at the through-hole conductor 39. The other connection portion 33 is connected to the external electrode 10 at the conductor 33a exposed on the end surface 1a.

The conductor 33b is located between the coil 30 and the conductor 33a closest to the coil 30 among the plurality of conductors 33a. The conductor 33b electrically connects the plurality of conductors 33a and the coil 30. The conductor 33b includes, for example, one end connected to the conductor 33a and another end connected to the coil 30. The one end of the conductor 33b is connected to the conductor 33a via the through-hole conductor 36. The other end of the conductor 33b is connected to the coil 30 via the through-hole conductor 37. Among the plurality of coil conductors 31 included in the coil 30, the coil conductor 31 closest to the end surface 1a is connected to the conductor 33b via the through-hole conductor 37. In FIG. 2, illustration of some of the plurality of conductors 33a and the through-hole conductors 36 is omitted.

The coil 30 and the connection portion 33 include an electrically conductive material. The electrically conductive material includes, for example, Ag, Pd, Au, Cu, or Al. The electrically conductive material includes, for example, an Ag—Pd alloy, an Ag—Cu alloy, an Ag—Au alloy, or an Ag—Pt alloy. The coil 30 and the connection portion 33 include, for example, the same electrically conductive material as the external electrode 10. The coil 30 and the connection portion 33 may include an electrically conductive material different from that of the external electrode 10.

The element body 1 includes a pair of element body portions 3a and 3b, and an element body portion 3c. The pair of element body portions 3a and 3b respectively include a corresponding end surface 1a of the pair of end surfaces 1a. For example, the element body portion 3a includes the one end surface 1a, and the element body portion 3b includes the other end surface 1a. The element body portion 3c is located between the element body portion 3a and the element body portion 3b in the first direction D1. For example, the one connection portion 33 is disposed in the element body portion 3a, the other connection portion 33 is disposed in the element body portion 3b, and the coil 30 is disposed in the element body portion 3c. In FIG. 3, illustration of the through-hole conductors 36 is omitted.

For example, the element body portion 3a may include a first element body portion, and the element body portion 3c may include a second element body portion. For example, the element body portion 3b may include a first element body portion, and the element body portion 3c may include a second element body portion.

The element body 1, for example, includes a plurality of insulator layers having electrical insulation properties. For example, the element body 1 includes a plurality of insulator layers laminated in the first direction D1. Each insulator layer includes, for example, a sintered body of a green sheet including a material to be described later. The element body 1 includes a sintered body. The element body 1 is obtained, for example, by firing a green element body including a plurality of laminated green sheets. That is, the element body 1 is obtained, for example, through a firing process. In the element body 1, the plurality of insulator layers are integrated with each other to an extent that the boundaries between them cannot be visually recognized. Each of the plurality of insulator layers, for example, has a rectangular shape as viewed from the first direction D1. For example, the plurality of coil conductors 31 and the conductors 33a and 33b are respectively disposed between adjacent insulator layers among the plurality of insulator layers.

The boundaries between each of the element body portions 3a, 3b and the element body portion 3c may be defined as follows.

For example, a plane that defines the boundary between the element body portion 3a and the element body portion 3c is parallel to the one end surface 1a, and this plane is in contact with a surface that is included in the coil conductor 31 closest to the one end surface 1a and opposes the one end surface 1a. For example, a plane that defines the boundary between the element body portion 3b and the element body portion 3c is parallel to the other end surface 1a, and this plane is in contact with a surface that is included in the coil conductor 31 closest to the other end surface 1a and opposes the other end surface 1a.

The element body portion 3c includes a plurality of regions 5a and a plurality of regions 5b. For example, the element body portion 3c includes four regions 5a and four regions 5b. The plurality of regions 5a are disposed at different positions in the first direction D1. The plurality of regions 5b are disposed at different positions in the first direction D1. The plurality of regions 5a and the plurality of regions 5b are disposed at positions different from each other in the first direction D1. The region 5b is located adjacent to and in contact with the region 5a. The region 5a and the region 5b are adjacent to and in contact with each other in the first direction D1. Each of the regions 5a and 5b is, for example, alternately disposed in the first direction D1. The region 5a is located between the regions 5b adjacent to each other among the plurality of regions 5b. The region 5b is located between the regions 5a adjacent to each other among the plurality of regions 5a. Each of the regions 5a and 5b includes at least one of the above-described insulator layers. For example, where the region 5a includes a first region, the region 5b includes a second region.

Each of the four regions 5b is disposed with intervals L1, L2, and L3 from each other in a direction from the element body portion 3a toward the element body portion 3b in the first direction D1. That is, the two regions 5b closer to the element body portion 3a relative to the central position CL1 are separated from each other by the interval L1. The two regions 5b located substantially at the center are separated from each other by the interval L2. The two regions 5b closer to the element body portion 3b relative to the central position CL1 are separated by the interval L3. For example, the intervals L1, L2, and L3 are substantially the same as each other. The four regions 5b are disposed at substantially equal intervals in the first direction D1. The plurality of regions 5b may be disposed at different intervals in the first direction D1.

The term “substantially equal intervals” includes, for example, a plurality of intervals being equal to each other, differences among the plurality of intervals being within a range of a preset slight difference, or differences among the plurality of intervals being within a manufacturing tolerance. For example, where each of the plurality of intervals L1, L2, and L3 falls within a range of ±20% of an average value of the plurality of intervals L1, L2, and L3, the plurality of regions 5b are considered to be disposed at substantially equal intervals.

For example, the end edge 10e of the electrode portion 10c and the region 5b are in contact with each other. For example, the end edge 10e and the region 5b closest to the element body portion 3b among the plurality of regions 5b are in contact with each other. For example, a part of the region 5b closest to the element body portion 3b is covered by the other electrode portion 10c, and the remaining part is exposed from the other electrode portion 10c. For example, the remaining part is not covered by the other electrode portion 10c. For example, the region 5b closest to the element body portion 3a is covered by the one electrode portion 10c. For example, the entirety of the region 5b closest to the element body portion 3a is covered by the one electrode portion 10c. The region 5b closest to the element body portion 3a may be in contact with the end edge 10e. The two regions 5b located substantially at the center are, for example, not in contact with the end edge 10e. The two regions 5b located substantially at the center are, for example, exposed from the electrode portion 10c. The two regions 5b located substantially at the center are, for example, not covered by the electrode portion 10c.

The insulator layer included in the region 5a includes a first material. That is, the region 5a includes the first material. The first material includes, for example, a magnetic material. The magnetic material includes, for example, a ferrite material. The ferrite material included in the first material includes, for example, a Ni—Cu—Zn-based ferrite material, a Mg—Cu—Zn-based ferrite material, a Ni—Cu—Zn—Mg-based ferrite material, a Ni—Cu-based ferrite material, or a Ni—Zn-based ferrite material.

The insulator layer included in the region 5b includes a second material. That is, the region 5b includes the second material. The second material includes, for example, a Ni—Cu—Zn-based ferrite material, a Mg—Cu—Zn-based ferrite material, a Ni—Cu—Zn—Mg-based ferrite material, a Ni—Cu-based ferrite material, a Cu—Zn-based ferrite material, a glass-based material, a forsterite material, a willemite material, an alumina material, a cordierite material, a steatite material, or a mullite material, or a mixed material of these materials.

The shrinkage rate of the second material is larger than the shrinkage rate of the first material. The shrinkage rate of the first material is the shrinkage rate of the first material in the firing process of the element body 1, and the shrinkage rate of the second material is the shrinkage rate of the second material in the firing process of the element body 1. The shrinkage rate of the first material is, for example, from 10% to 23%. The shrinkage rate of the second material is, for example, from 12% to 25%.

The shrinkage rates of the first material and the second material can be determined, for example, as follows.

A sample including the first material and a sample including the second material are prepared. Preparing the sample including the first material includes fabricating a green sheet including the first material, and cutting the fabricated green sheet into a predetermined size. Preparing the sample including the second material includes fabricating a green sheet including the second material, and cutting the fabricated green sheet into a predetermined size. The predetermined size is, for example, 1.6 mm ×0.8 mm.

Using a thermomechanical analyzer (TMA), a change in dimension in the longitudinal direction in each of the prepared samples is measured. The heating conditions in the thermomechanical analyzer are set to be the same as the firing conditions of the element body 1. The shrinkage rate is, for example, a value expressed as a percentage, obtained by dividing the difference between the dimension before the heat treatment and the dimension after the heat treatment by the dimension before the heat treatment.

The second material includes a material having a relative magnetic permeability and a relative permittivity that are respectively smaller than the relative magnetic permeability and the relative permittivity of the first material. Therefore, the second material may include a magnetic material as long as the second material includes a material having a relative magnetic permeability and a relative permittivity that are respectively smaller than the relative magnetic permeability and the relative permittivity of the first material. The insulator layer disposed in the element body portions 3a and 3b includes, for example, the first material.

The relative magnetic permeability of the first material is, for example, from 2 to 1500. The relative magnetic permeability of the second material included in the region 5b is, for example, from 1 to 10. For example, the relative magnetic permeability of the second material included in the region 5b is, for example, 1. The relative permittivity of the first material is, for example, from 8 to 20. The relative permittivity of the second material included in the region 5b is, for example, from 3 to 15.

For example, the region 5b has a relative magnetic permeability and a relative permittivity that are respectively smaller than the relative magnetic permeability and the relative permittivity of the region 5a. For example, the relative magnetic permeability of the region 5b is smaller than the relative magnetic permeability of the region 5a, and the relative permittivity of the region 5b is smaller than the relative permittivity of the region 5a.

The element body portion 3c includes three portions, namely, a portion 7a, a portion 7b, and a portion 7c. The portion 7a, the portion 7b, and the portion 7c are disposed in a first direction D1, for example, in the order of the portion 7a, the portion 7b, and the portion 7c. The portion 7b is located substantially at the center among the portions 7a, 7b, and 7c. The portion 7a is located near the element body portion 3a. The portion 7c is located near the element body portion 3b. For example, the portions 7a, 7b, and 7c divide the element body portion 3c into three parts of substantially equal length in the first direction D1.

Here, “substantially equal length” means, for example, that the lengths of the three portions are equal to each other, that a difference in length among the three portions is within a preset slight difference range, or that a difference in length among the three portions is within a manufacturing tolerance. For example, where the length of each of the portions 7a, 7b, and 7c in the first direction D1 is within a range of ±20% of an average value of their lengths in the first direction D1, it is considered that the portions 7a, 7b, and 7c divide the element body portion 3c into three parts of substantially equal length in the first direction D1.

Each of the portions 7a, 7b, and 7c, for example, includes the region 5a and the region 5b. For example, the portion 7a includes one region 5a and two regions 5b, the portion 7b includes two regions 5a and two regions 5b, and the portion 7c includes two regions 5a and one region 5b. The portions 7a and 7b adjacent to each other include one region 5a or 5b located at the boundary between the portions 7a and 7b in an overlapping manner. The portions 7b and 7c adjacent to each other include one region 5a or 5b located at the boundary between the portions 7b and 7c in an overlapping manner. In each of the plurality of regions 5b, three insulator layers including the second material are laminated continuously on each other without a region 5a being interposed therebetween.

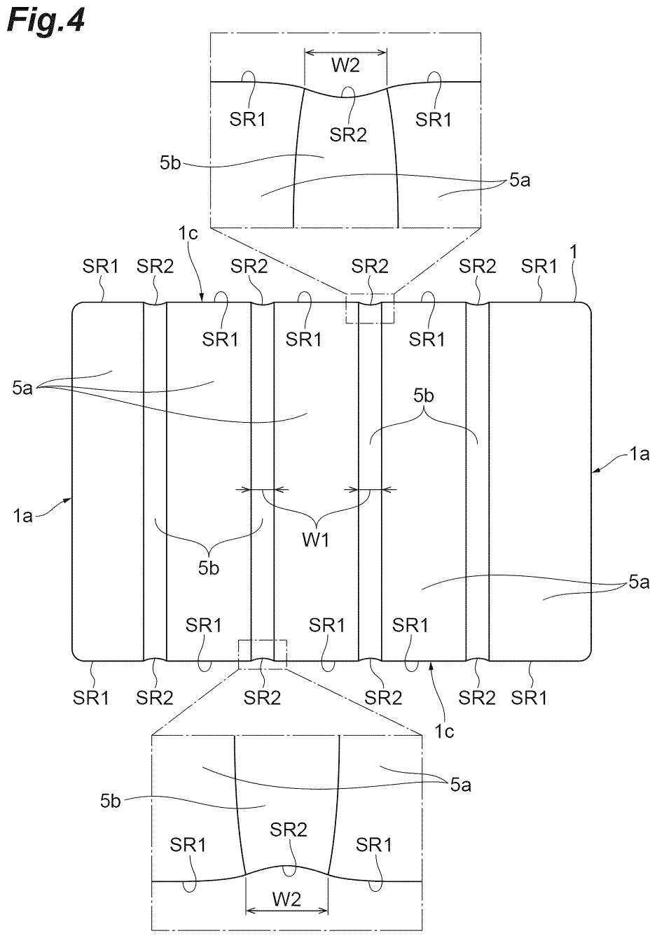

As illustrated in FIG. 4, the region 5a includes a surface region SR1 included in the side surface that couples the pair of end surfaces 1a. The region 5a includes the surface region SR1 included in each of the plurality of side surfaces 1c. The region 5a includes a plurality of surface regions SR1. Among the plurality of side surfaces 1c, the surface regions SR1 included in the side surfaces 1c adjacent to each other are continuous with each other. Each of the plurality of surface regions SR1 is positioned to extend in a direction in which a pair of side surfaces 1c adjacent to the side surface 1c including the surface region SR1 oppose each other.

The region 5b includes a surface region SR2 included in the side surface that couples the pair of end surfaces 1a. The region 5b includes the surface region SR2 included in each of the plurality of side surfaces 1c. The region 5b includes a plurality of surface regions SR2. Among the plurality of side surfaces 1c, the surface regions SR2 included in the side surfaces 1c adjacent to each other are continuous with each other. Each of the plurality of surface regions SR2 is positioned to extend in a direction in which a pair of side surfaces 1c adjacent to the side surface 1c including the surface region SR2 oppose each other.

FIG. 4 is a diagram illustrating a cross-sectional configuration of the element body. FIG. 4 includes an enlarged view of a part of the element body 1 (the regions 5a, 5b). In FIG. 4, illustration of the coil 30 is omitted. In FIG. 4, hatching indicating a cross section is omitted. For example, where the surface region SR1 includes a first surface region, the surface region SR2 includes a second surface region.

The surface regions SR1 and SR2 are included in the surface of the element body 1. In the region 5a and the region 5b that are adjacent to each other, the surface region SR1 and the surface region SR2 are continuous. For example, in a configuration in which the element body 1 includes only a plurality of the respective regions 5a and 5b, the side surface 1c includes only a plurality of the respective surface regions SR1 and SR2.

The surface region SR2 includes a natural surface. The surface region SR2 is the natural surface. The surface region SR1 may include a natural surface. The surface region SR1 may be a natural surface. The natural surface is a surface that is not mechanically or chemically processed. The natural surface is, for example, a surface constituted by the surfaces of crystal grains grown by firing.

The surface region SR2 is recessed more than the surface region SR1. For example, in a cross section of the element body 1 taken along a plane that is along the first direction D1 and perpendicular to a pair of side surfaces 1c opposing each other, the surface region SR2 is recessed more than the surface region SR1. As described above, the shrinkage rate of the second material is greater than the shrinkage rate of the first material. Therefore, in the element body 1 obtained through a firing process, the region 5b has shrunk more than the region 5a. Consequently, the surface region SR2 is recessed more than the surface region SR1.

For example, in the above-described cross section, the surface region SR2 is concavely recessed. The surface region SR2, for example, includes a curved surface. The surface region SR2 forms a recess on the side surface 1c. The recess formed by the surface region SR2, for example, has a groove shape. In this case, the surface region SR2 constitutes the bottom of a groove extending in a direction in which a pair of side surfaces 1c adjacent to the side surface 1c including the surface region SR2 oppose each other. The surface region SR1 may be a substantially flat surface. The surface region SR1 may be recessed. Even in a configuration where the surface region SR1 is recessed, the surface region SR2 is recessed more than the surface region SR1.

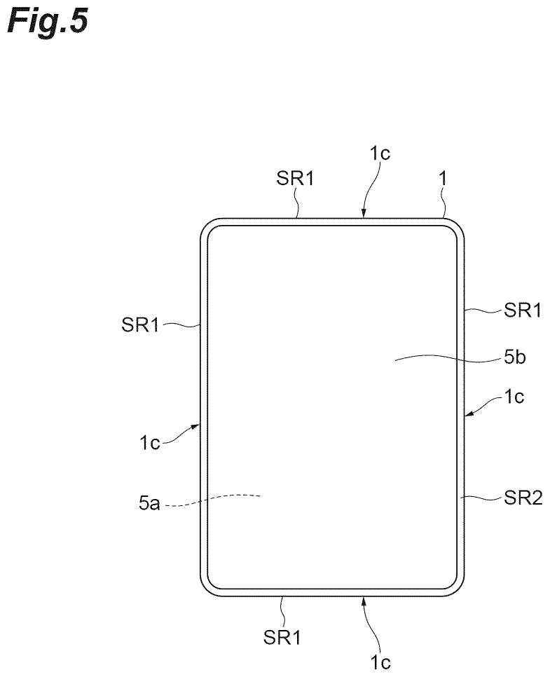

As described above, among the plurality of side surfaces 1c, the surface regions SR2 included in side surfaces 1c adjacent to each other are continuous with each other. Therefore, the recesses formed by the surface regions SR2 included in the side surfaces 1c adjacent to each other among the plurality of side surfaces 1c are also continuous with each other. As illustrated in FIG. 5, a groove that is continuous over the plurality of side surfaces 1c is formed in the element body 1 at a position corresponding to the region 5b. The surface regions SR2 included in the side surfaces 1c adjacent to each other among the plurality of side surfaces 1c may not be continuous with each other. FIG. 5 is a diagram illustrating a cross-sectional configuration of the element body. FIG. 5 illustrates, for example, a cross section when the region 5b is cut by a plane parallel to the pair of end surfaces 1a. In FIG. 5, illustration of the coil 30 is omitted. In FIG. 5, hatching indicating the cross section is omitted.

The recess depth of the surface region SR2 is from 0.5 μm to 5 μm. The recess depth of the surface region SR2 may be, for example, from 1 μm to 2 μm. The recess depth of the surface region SR2 may be defined by, for example, the maximum value of the recess depth in the above-described cross-section. In a configuration in which the surface region SR1 is a substantially flat surface, the recess depth of the surface region SR2 may be defined by the maximum value of a distance from a plane including the surface region SR1 to the surface region SR2 in a direction perpendicular to the plane.

The surface region SR2 has, for example, a width W2 smaller than a width W1 of the region 5b in the element body 1. In each surface region SR2, for example, the width W2 is smaller than the width W1. The width W2 is defined by the width of the region 5b on the surface of the element body 1. A ratio of the width W2 to the width W1 is, for example, equal to or greater than 0.6 and less than 1.0. As described above, the shrinkage rate of the second material is greater than the shrinkage rate of the first material. Therefore, in the element body 1 obtained through a firing process, the regions 5a located on both sides of the region 5b may be displaced to approach each other on a surface side of the element body 1 with the shrinkage of the region 5b. In this case, the width W2 tends to be smaller than the width W1.

The width W1 and the width W2 can be obtained, for example, as follows.

A cross-sectional photograph of the coil component ED1 (the element body 1) is obtained. The cross-sectional photograph is, for example, a photograph of a cross section when the coil component ED1 is cut by a plane along the first direction D1 and perpendicular to a pair of side surfaces 1c opposing each other. Image processing of the obtained cross-sectional photograph is performed using software. Based on a result of this image processing, a boundary of the region 5b is identified, and the width W1 and the width W2 on the obtained cross-sectional photograph are calculated.

As described above, the element body 1 is obtained, for example, by firing a green element body. The element body 1 is obtained, for example, through a firing process. In the firing process, the green element body shrinks. Stress may act on the obtained element body 1.

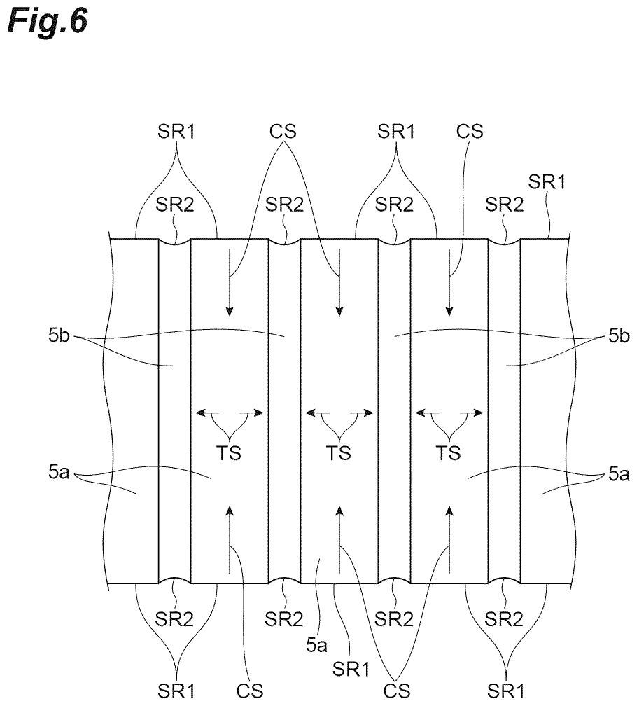

In the coil component ED1, where the element body 1 includes, in the element body portion 3c, the region 5a including the magnetic material, and the region 5b that is located adjacent to and in contact with the region 5a and includes the material having the shrinkage rate larger than that of the magnetic material, the region 5b has shrunk more than the region 5a. In the coil component ED1, the region 5a and the region 5b are in contact with each other. Therefore, as illustrated in FIG. 6, due to the shrinkage of the region 5b, a compressive stress CS acts on the region 5a from a region near the surface of the element body 1 toward the inside of the element body 1. A force based on this compressive stress CS is confined inside the element body 1, and is converted into a force directed from the region 5a toward the region 5b. This force directed from the region 5a toward the region 5b acts on the region 5a as a tensile stress TS. The coil component ED1 tends to balance the compressive stress CS and tensile stress TS acting on the region 5a in the element body portion 3c. For example, a balanced state between the compressive stress CS and tensile stress TS acting on the region 5a may allow a slight compressive stress CS to act on the region 5a. The slight compressive stress CS acting on the region 5a improves the relative magnetic permeability in the region 5a, thereby improving the inductance characteristics. FIG. 6 is a diagram schematically illustrating an action of the compressive stress and tensile stress.

With an increase in the compressive stress acting on the magnetic material, the inductance characteristics tend to decrease. With an increase in the tensile stress acting on the magnetic material, the inductance characteristics tend to decrease. However, a balanced state between the compressive stress and tensile stress acting on the magnetic material can improve the inductance characteristics. In the coil component ED1, the compressive stress and tensile stress acting on the magnetic material tend to be balanced. Therefore, the coil component ED1 can improve the inductance characteristics. Consequently, the coil component ED1 can improve the peak value of impedance.

In the coil component ED1, the region 5a may be located between the regions 5b adjacent to each other among the plurality of regions 5b.

The configuration in which the region 5a is located between the regions 5b adjacent to each other among the plurality of regions 5b further tends to balance the compressive stress CS and tensile stress TS acting on the region 5a. This configuration can reliably improve the inductance characteristics. Therefore, this configuration can reliably improve the peak value of the impedance.

In the coil component ED1, each of the plurality of regions 5a and each of the plurality of regions 5b may be alternately disposed in the first direction D1.

The configuration in which each of the plurality of regions 5a and each of the plurality of regions 5b are disposed alternately in the first direction D1 tends to reduce the interval between adjacent regions 5b in the element body portion 3c. The configuration in which the interval between adjacent regions 5b is small tends to increase the compressive stress CS acting on the region 5a, as compared with the configuration in which the interval between adjacent regions 5b is large. Therefore, the configuration in which each of the plurality of regions 5a and each of the plurality of regions 5b are disposed alternately in the first direction D1 can enhance the tendency to balance the compressive stress CS and tensile stress TS acting on the region 5a. This configuration can more reliably improve the inductance characteristics. Therefore, this configuration can more reliably improve the peak value of the impedance.

In the coil component ED1, at least one coil conductor 31 includes the coil conductor 31 disposed in the element body portion 3c, and the element body portion 3c is reliably present at a position through which a magnetic flux generated by the coil conductor 31 passes. That is, the element body portion 3c affects characteristics of the coil component, for example, impedance and inductance. The element body portion 3c includes the region 5a and the region 5b, and the region 5b has the relative magnetic permeability and the relative dielectric constant that are respectively smaller than the relative magnetic permeability and the relative dielectric constant that the region 5a has. Because the element body portion 3c includes the region 5b, the coil component ED1 appears an impedance peak in a high-frequency band. By the element body portion 3c including the region 5a, the coil component ED1 suppresses a decrease in inductance.

The coil component ED1 achieves high impedance in a high-frequency band, for example, from 700 MHz to 3 GHz.

In the coil component ED1, among the three portions 7a, 7b, and 7c that divide the element body portion 3c into three parts of substantially equal length in the first direction D1, the portion 7b located substantially at the center may include the region 5b.

In the configuration in which the portion 7b includes the region 5b, the region 5b that causes an impedance peak to appear in a high-frequency band is disposed in the portion 7b located substantially at the center. Therefore, this configuration reliably causes the impedance peak to appear in the high-frequency band.

In the coil component ED1, each of the plurality of portions 7a, 7b, and 7c may include the region 5a and the region 5b.

In the configuration in which each of the plurality of portions 7a, 7b, and 7c includes the region 5a and the region 5b, the region 5b that causes an impedance peak to appear in a high-frequency band is disposed in each of the plurality of portions 7a, 7b, and 7c. Therefore, this configuration more reliably causes the impedance peak to appear in the high-frequency band.

In the coil component ED1, the element body portion 3c may include the plurality of regions 5b that are disposed at different positions from each other in the first direction D1.

In the configuration in which the element body portion 3c includes the plurality of regions 5b described above, the plurality of regions 5b that cause an impedance peak to appear in a high-frequency band are disposed in the element body portion 3c. Therefore, this configuration causes the impedance peak to appear in the high-frequency band even more reliably.

In the coil component ED1, the plurality of regions 5b may be disposed at substantially equal intervals in the first direction D1.

In the configuration in which the plurality of regions 5b are disposed at substantially equal intervals in the first direction D1, the plurality of regions 5b that cause an impedance peak to appear in a high-frequency band are disposed at substantially equal intervals. Therefore, this configuration causes the impedance peak to appear in the high-frequency band even more reliably.

The coil component ED1 may include the plurality of coil conductors 31, and the plurality of coil conductors 31 may include the coil conductor 31 disposed in the region 5b.

In the configuration in which the plurality of coil conductors 31 include the coil conductor 31 disposed in the region 5b, the coil conductor 31 can be disposed in the region 5b. Therefore, the appearance of an impedance peak in a high frequency band is realized by the coil conductors 31. This configuration causes the impedance peak to appear in the high frequency band even more reliably.

The coil component ED1 may include the external electrodes 10 that are disposed at both ends of the element body 1 in the first direction D1 and are electrically connected to the coil 30. The element body 1 may include the side surface 1c coupling the pair of end surfaces 1a. The external electrode 10 may include the electrode portion 10c located on the side surface 1c. The end edge 10e of the electrode portion 10c and the region 5b may be in contact with each other.

The configuration in which the end edge 10e of the electrode portion 10c and the region 5b are in contact with each other reduces the stray capacitance formed between the coil 30 and the external electrode 10. Therefore, this configuration more reliably causes the impedance peak to appear in a high-frequency band.

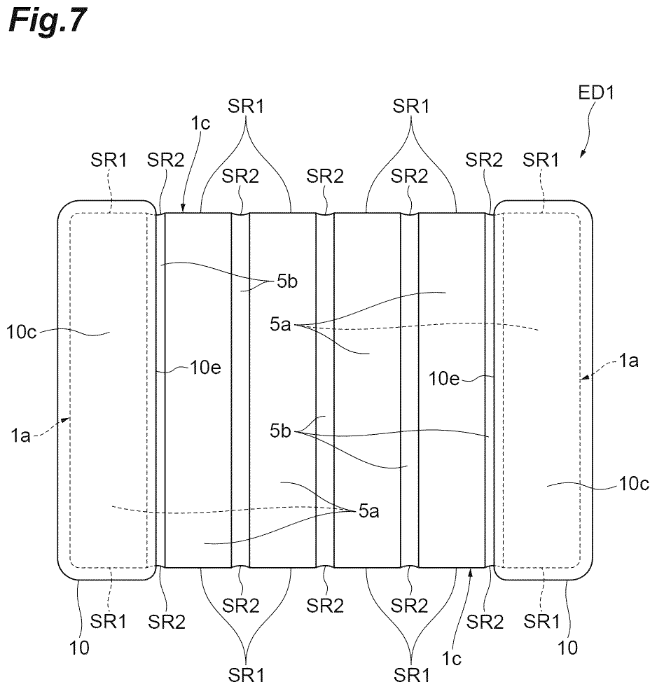

As illustrated in FIG. 7, each of the plurality of external electrodes 10 may include an end edge 10e located on the surface region SR2. FIG. 7 is a view illustrating a coil component according to a modification of the example.

A configuration in which each of the plurality of external electrodes 10 includes the end edge 10e located on the surface region SR2 can reliably define the position of the edge 10e.

For example, the external electrode 10 includes a sintered metal layer formed through sintering an electrically conductive paste applied to the surface of the element body 1. When the electrically conductive paste is applied, the electrically conductive paste tends to remain in a recess that the surface region SR2 forms on the side surface 1c. In this case, the position of the end edge 10e is defined to extend along the surface region SR2.

It is to be understood that not all aspects, advantages and features described herein may necessarily be achieved by, or included in, any one particular example. Indeed, having described and illustrated various examples herein, it should be apparent that other examples may be modified in arrangement and detail.

The respective numbers of the plurality of regions 5a and the plurality of regions 5b are not limited to the illustrated numbers. The plurality of regions 5b may be disposed symmetrically relative to the central position CL1 of the element body portion 3c. A configuration in which the plurality of regions 5b are disposed symmetrically relative to the central position CL1 of the element body portion 3c causes the impedance peak to occur more reliably in a high-frequency band.

What is claimed is:

1. A coil component comprising:
an element body; and
a coil disposed in the element body, wherein
the element body includes a first region and a second region in an element body portion in which the coil is disposed, the first region including a magnetic material, the second region located adjacent to and in contact with the first region and including a material having a shrinkage rate larger than a shrinkage rate of the magnetic material.

2. The coil component according to claim 1, wherein
the second region includes a plurality of second regions disposed at different positions in a coil axis direction of the coil, and
the first region is located between second regions adjacent to each other among the plurality of second regions.

3. The coil component according to claim 2, wherein
the first region includes a plurality of first regions disposed at different positions in the coil axis direction of the coil, and
each of the plurality of second regions and each of the plurality of first regions are alternately disposed in the coil axis direction of the coil.

4. The coil component according to claim 1, wherein
the element body includes a pair of end surfaces opposing each other in a coil axis direction of the coil, and a side surface coupling the pair of end surfaces,
the first region includes a first surface region included in the side surface, and
the second region includes a second surface region that is included in the side surface and is recessed more than the first surface region.

5. The coil component according to claim 4, wherein
a recess depth of the second surface region is from 0.5 μm to 5 μm.

6. The coil component according to claim 4, wherein
the second surface region has a width smaller than a width of the second region in the element body.

7. The coil component according to claim 4, wherein
the second surface region includes a natural surface.

8. The coil component according to claim 4, wherein
the side surface includes a plurality of side surfaces,
the second surface region is included in each of the plurality of side surfaces, and
recesses of the second surface region included in side surfaces adjacent to each other among the plurality of side surfaces are continuous with each other.

9. The coil component according to claim 4, further comprising an external electrode disposed on the element body and electrically connected to the coil, wherein
the external electrode includes an end edge located on the second surface region.

10. The coil component according to claim 1,
the second region has a relative magnetic permeability and a relative dielectric constant that are respectively smaller than a relative magnetic permeability and a relative dielectric constant of the first region.

11. The coil component according to claim 1,
the magnetic material includes a ferrite material.

12. A coil component comprising:
an element body including a pair of end surfaces opposing each other and a side surface coupling the pair of end surfaces; and
a coil disposed in the element body, wherein
the pair of end surfaces oppose each other in a coil axis direction of the coil,
the element body includes a first region and a second region that are adjacent to each other in the coil axis direction of the coil and are in contact with each other,
the first region includes a first surface region included in the side surface, and
the second region includes a second surface region that is included in the side surface and is recessed more than the first surface region.

13. The coil component according to claim 12, wherein
a recess depth of the second surface region is from 0.5 μm to 5 μm.

14. The coil component according to claim 12, wherein
the second surface region has a width smaller than a width of the second region in the element body.

15. The coil component according to claim 12, wherein
the second surface region includes a natural surface.

16. The coil component according to claim 12, wherein
the side surface includes a plurality of side surfaces,
the second surface region is included in each of the plurality of side surfaces, and
recesses of the second surface region included in side surfaces adjacent to each other among the plurality of side surfaces are continuous with each other.

17. The coil component according to claim 12, further comprising an external electrode disposed on the element body and electrically connected to the coil, wherein
the external electrode includes an end edge located on the second surface region.
